(19) United States
(12) Patent Application Publication
(10) Pub. No.: US 2017/0227450 A1
(43) Pub. Date: Aug. 10, 2017

(54) SAMPLE ARRAYS FOR MONITORING CORROSION AND RELATED METHODS

(71) Applicant: Baker Hughes Incorporated, Houston, TX (US)

(72) Inventors: Manuel Peter Hoegerl, Al Khobar (SA); Abdulaziz Abdulrhman AlMathami, Al Dammam (SA); Gaurav Agrawal, Aurora, CO (US)

(21) Appl. No.: 15/040,368

(22) Filed: Feb. 10, 2016

(51) Int. Cl. G01N 17/04; G01V 99/00

(52) U.S. Cl. CPC G01N 17/04; G01V 99/005

(57) ABSTRACT

A sample array includes a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species. A method of characterizing corrosive conditions includes providing a sample array in a subterranean formation, analyzing the corrosion proxy to estimate corrosion, and analyzing the at least one sample to determine a at least one property selected from the group consisting of a physical property and a concentration of a chemical species. Some methods include correlating a location in a borehole with corrosion and at least one of a physical property and concentration of a chemical species.

### CROSS-REFERENCE TO RELATED APPLICATION

The subject matter of this application is related to the subject matter of U.S. patent application Ser. No. 15/______,______ (attorney docket number 1684.04-P13140US), “SENSOR SYSTEMS, MULTI-BOREHOLE MONITORING SYSTEMS, AND RELATED METHODS,” filed on even date herewith, the entire disclosure of which is hereby incorporated herein by this reference.

### FIELD

Embodiments of the present disclosure relate generally to sample arrays and methods for monitoring corrosion, such as in downhole environments and in petroleum processing operations.

### BACKGROUND

Corrosion may occur during various operations within the oil-and-gas industry, such as in upstream (e.g., exploration and drilling), midstream (e.g., pipelines) or downstream (e.g., refining, distribution, etc.) operations. Corrosion may also occur throughout various chemical processing industries, and is a major source of expense and delay when equipment failures occur. Measurement of corrosion as a function of exposure time is typically difficult because parts may need to be removed from service for evaluation. Furthermore, modeling or simulation of corrosion can be difficult when process conditions are variable.

The oil and gas industry expends sizable sums to design cutting tools, such as downhole drill bits including roller-cone rock bits and fixed-cutter bits. Such drill bits may have relatively long service lives with relatively infrequent failure. In particular, considerable sums are expended to design and manufacture roller-cone rock bits and fixed-cutter bits in a manner that minimizes the probability of catastrophic drill bit failure during drilling operations. The loss of a roller cone or a polycrystalline diamond compact from a bit during drilling operations can impede the drilling operations and, at worst, necessitate rather expensive operations for retrieving the bit or components thereof from the wellbore.

Diagnostic information related to a drill bit and certain components of the drill bit may be linked to the durability, performance, and the potential failure of the drill bit. In addition, characteristic information regarding the rock formation may be used to estimate performance and other characteristics related to drilling operations. Logging while drilling (LWD) and measuring while drilling (MWD) measurements are conventionally obtained from measurements behind (e.g., several feet away from) the drill head.

Drill bits, other drilling tools, as well as logging subs and tools including instruments and other downhole assemblies used for oil and gas exploration and production are often exposed to corrosive conditions, such as high temperatures, high pressures, reactive chemicals, and abrasive materials. Therefore, these bits, subs, tools, and other downhole components corrode and degrade during use. In addition, scale (i.e., debris and materials from the wellbore or from fluids therein) may be deposited on such downhole components used for exploration and production of oil and gas, which may foul the operation of the tools and create flow restrictions. Corrosion may occur throughout a subterranean formation and in processing equipment, and may vary with time and location. Surface monitoring of chemical variables related to corrosion may be of some value, but may not be fully representative of downhole conditions due to changes in temperature and pressure that occur between the formation and the surface.

Corrosion monitoring is also important for surface systems and components, such as pipelines, pumps, turbines, tanks, and any other devices. Corrosion monitoring may be particularly important for systems under pressure, systems in contact with particularly hazardous materials, or systems in close proximity to inhabited areas. Extraction of fluid samples for testing variables related to corrosion may be of some value, but may not be fully representative of process conditions due to changes in temperature and pressure that occur when samples are extracted.

### BRIEF SUMMARY

In some embodiments, a sample array for includes a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species.

A method of characterizing corrosive conditions includes providing a sample array in a subterranean formation. The sample array comprises a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species. The method further comprises analyzing the corrosion proxy to estimate corrosion experienced by the sample array, and analyzing the at least one test sample to determine at least one property selected from the group consisting of a physical property exhibited by the sample array and a concentration of at least one chemical species.

In certain embodiments, a method of characterizing conditions in a subterranean volume includes providing a plurality of sample arrays at longitudinally spaced locations in a borehole extending through one or more subterranean formations. Each sample array comprises a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species. The method further comprises analyzing the corrosion proxy of each sample array to estimate corrosion experienced by each sample array, analyzing the at least one test sample of each sample array to determine at least one property selected from the group consisting of a physical property experienced by each sample array and a concentration of at least one chemical species at the location of each array, and correlating a location in the borehole with the corrosion and the at least one of a physical property and the concentration of the at least one chemical species.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified schematic view illustrating a sample array for monitoring corrosion;

FIG. 2 is a simplified schematic side view of a test sample;

FIG. 3 is a simplified schematic diagram illustrating a cross-section of a subterranean formation, and shows how the sample array shown in FIG. 1 may be used to monitor properties associated with corrosion; and

FIG. 4 is a simplified schematic block diagram of a sensor sample array shown in FIG. 1.

### DETAILED DESCRIPTION

The illustrations presented herein are not meant to be actual views of any particular material, apparatus, system, or method, but are merely idealized representations employed to describe certain embodiments. For clarity in description, various features and elements common among the embodiments may be referenced with the same or similar reference numerals.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, any relational term, such as “first,” “second,” “over,” “top,” “bottom,” “underlying,” etc., is used for clarity and convenience in understanding the disclosure and accompanying drawings and does not connote or depend on any specific preference, orientation, or order, except where the context clearly indicates otherwise.

As used herein, the term “corrosion” means physical and/or chemical degradation.

As used herein, the term “corrodible” in reference to a material means susceptible to corrosion in an environment in which the material is to be placed.

As used herein, the term “particle” means and includes any coherent volume of solid matter. As used herein, the term “nanoparticle” means and includes any particle having an average particle diameter of about 100 nm or less.

As used herein, the term “nano-structured material” means and includes any solid material having a largest dimension of about 100 nm or less. Nano-structured materials include needles, brushes, pins, cubes, etc.

As used herein, the term “test sample” means and includes an active or passive body formulated and/or configured to respond to a change in conditions. Test samples include electronic devices, such as thermocouples, transducers, pH meters, etc., as well as reactive materials, substrates having reactive layers thereon, or any other body capable of reacting to conditions.

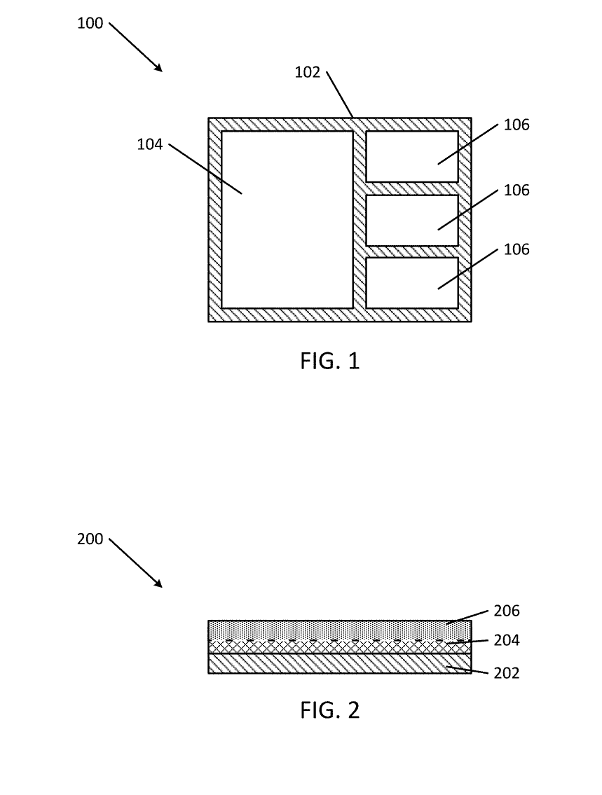

FIG. 1 is a simplified schematic view illustrating a sample array 100 for monitoring downhole corrosion. The sample array 100 may include a substrate 102 to which a corrosion proxy 104 and test samples 106 may be coupled. Though shown as having three test samples 106, the sample array 100 may include any number of test samples 106, such as one, two, four, five, etc.

The substrate 102 may be any structure configured to provide physical support for the corrosion proxy 104 and the test samples 106. In some embodiments, the substrate 102 may include a silicon or silicon dioxide wafer. The substrate 102 may be formulated to be inert when exposed to the conditions expected to be encountered by the sample array 100, such that the substrate 102 may retain its physical characteristics while the sample array 100 is in use. The substrate 102 may include one or more layers of material.

The corrosion proxy 104 may be any material formulated and configured to corrode in response to a corrosive environment. The corrosion proxy 104 may include one or more metal plates mounted in an insulating material (which may be referred to in the art as a “coupon”), and may have a generally planar surface configured to be exposed to drilling fluid. The use of corrodible coupons to estimate corrosion is described in U.S. Pat. No. 4,603,113, “Corrosion Testing,” issued Jul. 29, 1986, the entire disclosure of which is hereby incorporated by this reference. The corrosion proxy 104 may be selected to include a material selected to have a similar composition to materials commonly used in forming or servicing wellbores, such as carbon steel, zinc oxide, stainless steel, a nickel alloy, a braze material, a hardfacing material, solder, etc. The corrosion proxy 104 may be a sacrificial material, and may be a corrodible material configured to be at least partially consumed during a test.

In some embodiments, the corrosion proxy 104 may include a nano-structured material. For example, the corrosion proxy 104 may include a nano-structured material (e.g., a layer of nanoparticles) bonded to a substrate. The nano-structured material may include a material used in tools and components thereof used in wellbores, such as carbon steel, zinc oxide, stainless steel, a nickel alloy, a braze material, a hardfacing material, solder, etc. Nano-structured materials may experience corrosion at higher rates than flat plates, due to the increased surface area per volume. Thus, if the corrosion proxy 104 includes a nano-structured material, it may exhibit a physical or chemical change in response to a relatively less corrosive environment or over relatively shorter sampling times than conventional coupons. Such a corrosion proxy 104 may be able to provide statistically meaningful results after a few hours or days in a corrosive environment, instead of weeks or months that may be required for conventional coupons. A corrosion proxy 104 that includes a nano-structured material may be capable of producing data with a higher signal-to-noise ratio than conventional coupons.

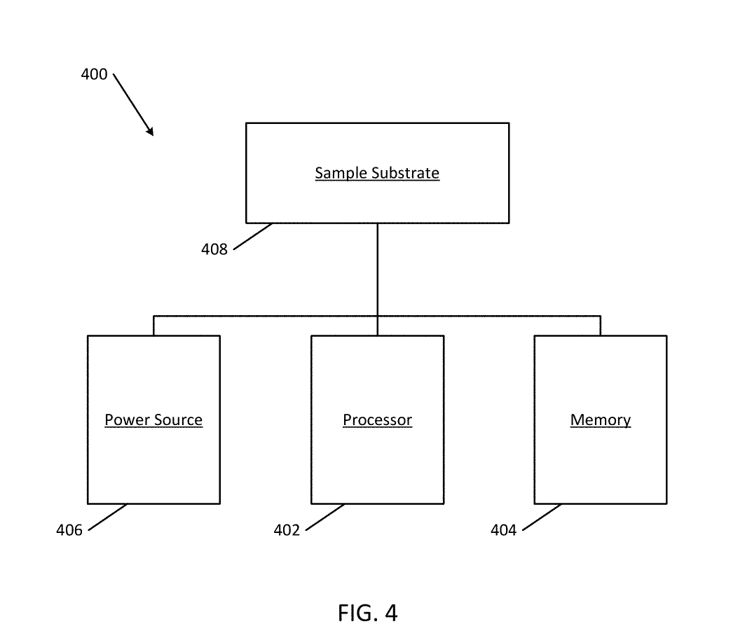

In some embodiments, the test samples 106 may include various physical or chemical detectors or sensors. For example, test samples 106 configured for detecting physical properties may include pressure sensors, temperature sensors, fluid flow sensors, vibration detectors, accelerometers, and electromagnetic field sensors. Such a test sample 106 may include an electronic device, such as a thermocouple or piezoelectric transducer, which may be configured to transmit a signal to an electronic circuit. The electronic circuit may be included within the test sample 106, or may be external. FIG. 4 illustrates a simplified schematic block diagram of a sensor 400 that may be included in the sample array 100. The electronic circuit may include a processor 402, a memory 404, a power source 406, etc., to record data from a sample substrate 408. In certain embodiments, the electronic circuit may include a communications module to transmit data to another device, such as another sample array 100, a central data collection system, a network, etc. In some embodiments, test samples 106 may not include any electronic circuits, but may instead passively react to conditions, such as by changing a material phase. Such test samples 106 may be removed after a period of time for analysis.

The sample array 100 may also include one or more test samples 106 configured to detect chemical species. In some embodiments, a test sample 106 may include two or more regions, each configured to detect different chemical species. FIG. 2 is a simplified schematic side view of a test sample 200, which may be any of the test samples 106 shown in FIG. 1. The test sample 200 may include a substrate 202, an optional intermediate material 204, and a chemically active layer 206. The substrate 202 may be the same as the substrate 102 shown in FIG. 1, or may be a separate substrate (e.g., the substrate 202 of the test sample 200 may be bonded to the substrate 102 shown in FIG. 1). The intermediate material 204, if present, may facilitate bonding between the chemically active layer 206 and the substrate 202. For example, the intermediate material 204 may be an adhesive material, a semiconductor material, a metal, an insulator, etc. In some embodiments, the chemically active layer 206 may be directly attached to the substrate 202, without any intermediate material 204.

The chemically active layer 206 may be any material formulated to interact with a chemical species, such that a concentration of the chemical species may be inferred based on analysis (either in situ or at a later time) of the chemically active layer 206. For example, the chemically active layer 206 may be configured to interact with CO₂, H₂S, chloride ions, iron ions, calcium ions, magnesium ions, chromium ions, manganese ions, hydroxyl ions or hydronium ions (i.e., to measure pH), etc. The chemically active layer 206 may include a nano-structured material (e.g., nanoparticles, etc.), such as in a coating over the substrate 202. Nano-structured materials may be useful as chemical detectors because they may be more selective toward a chemical species than, for example, continuous generally planar surfaces of the same material. Thus, a chemically active layer 206 containing nano-structured material may have a lower detection limit, may be more sensitive to relatively lower concentrations of a chemical species, and may yield results having a higher signal-to-noise ratio. However, in some embodiments, the chemically active layer 206 may include a generally planar surface of material, such as a metal, a metal oxide, etc.

The chemically active layer 206 may include different materials based on the chemical species to be detected. For example, to detect CO₂, the chemically active layer 206 may include CuO, BaTiO₃, SnO₂, iron oxide or another metal oxide in a perovskite form, etc. To detect H₂S, the chemically active layer 206 may include a metal oxide, such as CuO, SnO₂, WO₃, etc. To detect chloride ions, the chemically active layer 206 may include carbon, AgNO₃, WO₃, In₂O₃, Fe₂O₃, etc. To detect iron ions, the chemically active layer 206 may include a chalcogenide glass, a porphyrin, etc.

The chemically active layer 206 may be a homogeneous material in compositions, morphology, orientation, and surface roughness. If the chemically active layer 206 includes a nano-structured material, the chemically active layer 206 may have a relatively higher active surface area than a flat, smooth surface of similar composition. For example, the chemically active layer may having an active surface area at least 10 times, at least 50 times, or even at least 100 times the surface area of a flat surface of similar dimensions. Thus, the chemically active layer 206 may be relatively more sensitive to selected chemical species. Furthermore, a high surface area may enable measurement of a wider range of concentrations of chemical species than flat, smooth surfaces.

The test sample 200 may be formed by providing a precursor material over the substrate 202. For example, a precursor to the intermediate material 204 or to the chemically active layer 206 may be over the substrate 202. In some embodiments, the precursor may be deposited by, for example, screen printing, spin coating, evaporation, sputtering (physical vapor deposition), chemical vapor deposition, or any other selected method. The precursor may be heat-treated, which may form the intermediate material 204 or the chemically active layer 206. In embodiments in which the precursor forms the intermediate material 204, the chemically active layer 206 may be attached to the intermediate material 204. The chemically active layer 206 may be deposited by, for example, screen printing, spin coating, evaporation, sputtering, chemical vapor deposition, or any other selected method. If the chemically active layer 206 includes a nano-structured material, the nano-structured material may be formed in situ (e.g., by nucleation from a gas or liquid phase) or may be deposited as particles formed in a prior process.

In some embodiments, the chemically active layer 206 may include an electrically conductive material, which may respond to changes in electrical properties of a subterranean environment (e.g., pH, ion concentration, etc.).

In some embodiments, multiple test samples 200 may be formed in a single operation, and may be cut apart for use in individual sample arrays 100 (FIG. 1). Such a process may allow for economies of scale with respect to manufacturing, and may enhance quality control of the individual test samples 200 formed. Thus, sample arrays 100 may be prepared in large quantities, and the sample arrays 100 may be used interchangeably.

Returning to FIG. 1, the sample array 100 may include multiple test samples 106, and may include multiple test samples 106 configured to detect different chemical species or different concentration ranges of a chemical species. For example, the sample array 100 may include a test sample 106 for detecting downhole temperature (e.g., as disclosed in U.S. Pat. No. 5,130,705, “Downhole Well Data Recorder and Method,” issued Jul. 14, 1992, the entire disclosure of which is hereby incorporated by this reference), a test sample 106 for detecting chloride concentration (e.g., as disclosed in U.S. Pat. No. 6,925,392, “Method for Measuring Fluid Chemistry in Drilling and Production Operations,” issued Aug. 2, 2005, the entire disclosure of which is hereby incorporated by this reference), a test sample 106 for detecting a partial pressure of CO₂ (e.g., as disclosed in U.S. Patent Application Publication No. 2015/0122487, “Downhole Electrochemical Sensor and Method of Using Same,” published May 7, 2015, the entire disclosure of which is hereby incorporated by this reference), a test sample 106 for detecting a partial pressure of H₂S (e.g., as disclosed in U.S. Patent Application Publication No. 2015/0122487), a test sample 106 for detecting pH (e.g., as disclosed in U.S. Patent Application Publication No. 2015/0122487), and a test sample 106 for detecting a concentration of sulfur. Thus, the sample array 100 may provide multiple parameters that may be correlated to one another or to corrosion experienced by the corrosion proxy 104. Such information may be relatively more valuable when collected downhole rather than by a sample extracted at the surface of the earth because conditions may change en route to the surface, and collection of samples from various locations may become cost-prohibitive.

The sample array 100 may be removed from its location in a formation and brought to the surface for analysis. The sample array 100 may be analyzed by any appropriate means, such as spectroscopy (e.g., Raman, infrared, UV visible, etc.), thermogravimetric analysis, electrochemistry, etc. The sample array 100 may be analyzed in a laboratory using conventional laboratory equipment, or may be analyzed in a field-deployable module specifically adapted for use with the sample array 100. For example, the corrosion proxy 104 may be analyzed with a caliper to measure thickness, with an X-ray diffraction (XRD) device to determine microstructure, with an X-ray fluorescence (XRF) device to determine composition, with a scanning electron microscope (SEM) to determine surface topography, or with energy-dispersive X-ray spectroscopy (EDX) to determine elements present, or any other appropriate method or combination of methods. The test samples 106 of the sample array 100 may be separated from one another for analysis, and each may be analyzed by different methodology, which may be the same or different from methodology used to analyze the corrosion proxy 104 (e.g., XRD, XRF, SEM, EDX, etc.), depending on the chemical species to be analyzed. In embodiments in which one or more test samples 106 include electronic components such as a processor and/or memory, data may be transferred from those sample(s) 106 via a wired or wireless connection to a computer system.

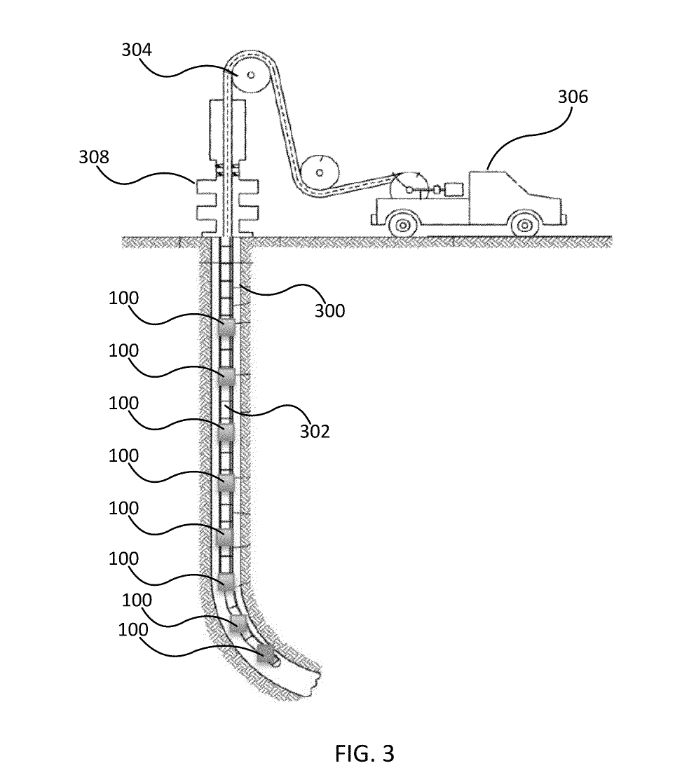

FIG. 3 is a simplified schematic diagram illustrating a cross-section of a subterranean formation, and shows how the sample array 100 shown in FIG. 1 may be used to monitor properties associated with corrosion. A number of sample arrays 100 may be provided within a borehole 300 to measure conditions therein. A wireline 302 may be placed within the borehole 300. The wireline 302 may be guided at the surface of the earth by one or more pulleys 304, a service truck 306, a derrick 308, or other known components. The wireline 302 may be a simple slickline with no active conductors for sending power and sending and receiving data, suspended within the borehole 300, but may alternatively be any other component. In some embodiments, the sample array 100 may be configured as a module inserted into the borehole 300 on a portion of a drill string or on coiled tubing.

The wireline 302 may carry a number of sample arrays 100 configured to measure conditions within the borehole 300. Each sample array 100 may be spaced apart from adjacent sample arrays 100 as desired to balance interests of, for example, costs, quality and quantity of data, speed of data analysis, etc. For example, sample arrays 100 may be spaced relatively close together in or near expected pay zones, in or near expected zones of high corrosion, etc., and relatively farther apart in areas of expected relatively inert wellbore fluids. The sample arrays 100 may be placed within the borehole 300 for a period of time, during which the sample arrays 100 are subjected to temperatures, pressures, chemical environments, etc., in the borehole 300. The sample arrays 100 may be removed after a period of time for analysis. The wireline 302 may be withdrawn from the borehole 300, and each sample array 100 may be removed from the wireline 302 for analysis. Thus, the sample arrays 100 may provide data from many different locations within the borehole 300. The sample arrays 100 may be separated into different parts for analysis in different equipment as desired.

In certain embodiments, for example, when run on a wireline 302 having active conductors for power and data transmission, the sample arrays 100 may communicate data to the surface (e.g., to a control panel on the service truck 306 or derrick 308) through the wireline 302, as is conventional. For example, the sample arrays 100 may transmit temperature and pressure to the surface. Transmission of data may be continuous or non-continuous.

In some embodiments, the corrosion proxy 104 may be measured independently of one or more of the test samples 106. For example, if one of the test samples 106 measures temperature or pressure continuously, the corrosion proxy 104 may measure corrosion over a period of time, such as over a period of hours, days, or weeks (as determined by gravimetric means, by measuring thickness, by analysis with XRD, XRF, SEM, EDX, etc.) by withdrawing the sample array 100 from service and analyzing the corrosion proxy 104. Thus, the temperature or pressure may be continuously transmitted to the surface, and the corrosion experienced by the corrosion proxy 104 may be measured at a point in time after exposure.

The sample arrays 100 may be used for any application in which additional information about corrosion would be beneficial, such as in upstream, midstream, or downstream operations. For example, one or more sample arrays 100 may be deployed to measure corrosion, physical properties, and chemical properties in piping within a processing plant (e.g., in flue pipes, material inputs, product outputs, intermediate flows, etc.). Such sample arrays 100 may assist operators in understanding conditions throughout a plant or other operation.

Use of sample arrays 100 as disclosed herein may enable data collection on a large scale, and may improve the ability to model corrosion processes by collecting specific physical and chemical properties near the site of corrosion proxies 104. The sample arrays 100 may be used to measure properties directly or indirectly. For example, a corrosion rate of one material may be measured directly by placing that material in the sample arrays 100 (e.g., as the corrosion proxy 104), or may be calculated based on parameters that may be measured directly, such as temperature, pressure, H₂S concentration, acidity, salinity, etc.

The sample arrays 100 may be configured to be stable and operable under conditions expected to be encountered in subterranean formations or hydrocarbon production systems. For example, the sample arrays 100 may be operable (i.e., may detect corrosion, physical, and/or chemical properties as designed) at pressures up to about 69 MPa (10,000 psi), up to about 138 MPa (20,000 psi) or even up to about 241 MPa (35,000 psi). The sample arrays 100 may be operable at temperatures up to about 150° C., up to about 205° C., or even up to about 260° C. or higher.

A method of characterizing downhole conditions may include providing one or more sample arrays 100 in a subterranean formation, analyzing the corrosion proxies 104 to estimate corrosion experienced by the sample arrays 100, and analyzing data collected from the test samples 106 to determine a physical property and/or a concentration of a chemical species.

The corrosion proxies 104 may be analyzed by gravimetric methods (i.e., by measuring a mass of each corrosion proxy 104). A change in mass of a corrosion proxy 104 may be correlated to a corrosion rate for a particular material. The test samples 106 may be analyzed by any appropriate method, such as by impedance spectroscopy, electrochemical methods, optical methods, microscopy, etc. For example, test samples 106 configured to measure temperature, pressure, fluid flow rate, vibration, acceleration, or electromagnetic field may record data on a digital storage medium, and the medium may be connected to a computer or a network to read the data. Test samples 106 configured to detect chemical species may be analyzed in a laboratory by, for example, reacting the test samples 106 with a reagent, dissolving a chemical species from the test samples 106, desorbing gaseous or liquid species from a surface of the test samples 106, extracting a chemical species from the test samples 106, measuring electrical properties of the test samples 106, analyzing the test samples 106 by spectroscopy, spectrometry, microscopy, x-ray, neutron activation, analysis of micro-structure, or any other method. Test samples 106 or portions thereof may be analyzed in different ways depending on the property to be measured. In some embodiments, test samples 106 may be cut or otherwise separated to promote efficient analysis (e.g., simultaneous analysis of different properties).

Data collected from sample arrays 100 may be used to correlate locations within a subterranean formation with corrosion levels. For example, zones of highly corrosive conditions may be identified in three dimensions (e.g., in a computer-generated, interactive visual representation), such that drilling operations may be better planned. For example, exposure of drill equipment to highly corrosive zones may be minimized or avoided altogether. If highly corrosive zones cannot be reasonably avoided, operators can focus monitoring and maintenance efforts on such zones if the location of the highly corrosive zones is well characterized. For example, equipment known to be exposed to highly corrosive zones may be inspected more frequently than other equipment, such that inspection efforts and resources can be used more efficiently.

Sample arrays 100 and methods as disclosed herein may offer advantages over conventional methods of measuring corrosion. For example, sample arrays 100 may enable an operator to economically place multiple sample arrays 100 in a formation to obtain information about conditions at multiple test sites. Furthermore, more information may be available at each test site because the sample arrays 100 may provide more information than conventional corrosion sensors, and may provide information with less exposure time. The use of multiple sample arrays 100 may therefore provide a more complete picture of downhole conditions and ongoing chemical reactions. Sample arrays 100 may be used to identify changes in a well related to productivity. Problems may be identified more quickly due to the sensitivity of sample arrays 100, and therefore problems may be corrected before catastrophic failures occur. Thus, overall well productivity may increase. The use of sample arrays 100 may enable a shift from time-based maintenance schedules toward condition-based maintenance, and, thus, may allow more efficient allocation of maintenance resources. Furthermore, sample arrays 100 may allow operators to test novel corrosion inhibitors and to improve the efficiency of corrosion inhibitor treatments.

Additional non-limiting example embodiments of the disclosure are described below.

Embodiment 1: A sample array, comprising a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species.

Embodiment 2: The sample array of Embodiment 1, wherein the corrosion proxy comprises a sacrificial coupon.

Embodiment 3: The sample array of Embodiment 2, wherein the sacrificial coupon comprises nano-structured material.

Embodiment 4: The sample array of any of Embodiments 1 through 3, wherein the at least one test sample comprises a coating over a surface, the coating comprising a nano-structured material.

Embodiment 5: The sample array of Embodiment 4, wherein the nano-structured material comprises a material formulated to react with a chemical species expected to be encountered in a downhole environment.

Embodiment 6: The sample array of Embodiment 4 or Embodiment 5, wherein the nano-structured material comprises a material formulated to react with at least one material selected from the group consisting of CO₂, H₂S, chloride ions, iron ions, calcium ions, magnesium ions, chromium ions, manganese ions, hydroxyl ions, and hydronium ions.

Embodiment 7: The sample array of any of Embodiments 1 through 6, wherein the at least one test sample comprises at least two regions formulated and configured to measure at least two different chemical species.

Embodiment 8: The sample array of any of Embodiments 1 through 7, wherein the at least a first test sample is configured to measure a physical property selected from the group consisting of pressure, temperature, fluid flow rate, vibration, acceleration, and electromagnetic field.

Embodiment 9: The sample array of any of Embodiments 1 through 8, wherein the at least one test sample comprises at least a first test sample formulated and configured to measure at least one physical property, and at least a second test sample formulated and configured to detect at least one chemical species.

Embodiment 10: A method of characterizing corrosive conditions, comprising providing a sample array in a subterranean formation. The sample array comprises a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species. The method further comprises analyzing the corrosion proxy to estimate corrosion experienced by the sample array, and analyzing the at least one test sample to determine at least one property selected from the group consisting of a physical property exhibited by the sample array and a concentration of at least one chemical species.

Embodiment 11: The method of Embodiment 10, wherein analyzing the corrosion proxy comprises analyzing the sacrificial coupon by at least one of gravimetric analysis, impedance spectroscopy, electrochemical analysis, optical analysis, and microscopy.

Embodiment 12: The method of Embodiment 10 or Embodiment 11, wherein the at least one test sample comprises a coating comprising a nano-structured material.

Embodiment 13: The method of Embodiment 12, wherein analyzing the at least one test sample comprises at least one process selected from the group consisting of reacting the coating with a reagent, dissolving a chemical species from the coating, desorbing a chemical species from the coating, and extracting a chemical species from the coating.

Embodiment 14: The method of any of Embodiments 10 through 13, wherein analyzing the at least one test sample comprises detecting at least one material selected from the group consisting of CO₂, H₂S, chloride ions, iron ions, calcium ions, magnesium ions, chromium ions, manganese ions, hydroxyl ions, and hydronium ions.

Embodiment 15: The method of any of Embodiments 10 through 14, wherein analyzing the at least one test sample comprises analyzing at least two regions of the at least one test sample to determine concentrations of at least two different chemical species.

Embodiment 16: The method of any of Embodiments 10 through 15, wherein analyzing the at least a one sample comprises determining a physical property selected from the group consisting of pressure, temperature, fluid flow rate, vibration, acceleration, and electromagnetic field.

Embodiment 17: The method of any of Embodiments 10 through 16, further comprising removing the sample array from the subterranean formation before analyzing the corrosion proxy and the at least one test sample.

Embodiment 18: The method of any of Embodiments 10 through 17, further comprising maintaining the sample array within the subterranean formation for a period time from about six hours to about sixty days.

Embodiment 19: The method of any of Embodiments 10 through 18, wherein the at least one test sample comprises at least a first test sample formulated and configured to measure at least one physical property, and at least a second test sample formulated and configured to detect at least one chemical species. Analyzing the at least one test sample further comprises determining at least one physical property exhibited by the sample array and a concentration of at least one chemical species.

Embodiment 20: A method of characterizing conditions in a subterranean volume, comprising providing a plurality of sample arrays at longitudinally spaced locations in a borehole extending through one or more subterranean formations. Each sample array comprises a substrate, a corrosion proxy coupled to the substrate, and at least one test sample coupled to the substrate. The corrosion proxy is formulated and configured to relate to corrosion of material near the sample array. The at least one test sample is formulated and configured to measure at least one of a physical property and a chemical species. The method further comprises analyzing the corrosion proxy of each sample array to estimate corrosion experienced by each sample array, analyzing the at least one test sample of each sample array to determine at least one property selected from the group consisting of a physical property experienced by each sample array and a concentration of at least one chemical species at the location of each array, and correlating a location in the borehole with the corrosion and the at least one of a physical property and the concentration of the at least one chemical species.

Embodiment 21: The method of Embodiment 20, further comprising selecting a drilling location based at least partially on the corrosion and the at least one of a physical property and the concentration of the chemical species.

Embodiment 22: The method of Embodiment 20 or Embodiment 21, further comprising inspecting equipment used in the borehole extending through the one or more subterranean formations based on the corrosion and the at least one of a physical property and the concentration of the chemical species in the subterranean volume.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various tool types and configurations.

What is claimed is:

1. A sample array, comprising:
a substrate;
a corrosion proxy coupled to the substrate, the corrosion proxy formulated and configured to relate to corrosion of material near the sample array; and
at least one test sample coupled to the substrate, the at least one test sample formulated and configured to measure at least one of a physical property and a chemical species.

2. The sample array of claim 1, wherein the corrosion proxy comprises a sacrificial coupon.

3. The sample array of claim 2, wherein the sacrificial coupon comprises a nano-structured material.

4. The sample array of claim 1, wherein the at least one test sample comprises a coating over a surface, the coating comprising a nano-structured material.

5. The sample array of claim 4, wherein the nano-structured material comprises a material formulated to react with a chemical species expected to be encountered in a downhole environment.

6. The sample array of claim 4, wherein the nano-structured material comprises a material formulated to react with at least one material selected from the group consisting of CO₂, H₂S, chloride ions, iron ions, calcium ions, magnesium ions, chromium ions, manganese ions, hydroxyl ions, and hydronium ions.

7. The sample array of claim 1, wherein the at least one test sample comprises at least two regions formulated and configured to measure at least two different chemical species.

8. The sample array of claim 1, wherein the at least one test sample is configured to measure a physical property selected from the group consisting of pressure, temperature, fluid flow rate, vibration, acceleration, and electromagnetic field.

9. A method of characterizing corrosive conditions, comprising:
providing a sample array in a subterranean formation, the sample array comprising:
a substrate;
a corrosion proxy coupled to the substrate, the corrosion proxy formulated and configured to relate to corrosion of material near the sample array; and
at least one test sample coupled to the substrate, the at least one test sample formulated and configured to measure at least one of a physical property and a chemical species;
analyzing the corrosion proxy to estimate corrosion experienced by the sample array;
analyzing the at least one test sample to determine at least one property selected from the group consisting of a physical property exhibited by the sample array and a concentration of at least one chemical species.

10. The method of claim 9, wherein analyzing the corrosion proxy comprises analyzing the sacrificial coupon by at least one of gravimetric analysis, impedance spectroscopy, electrochemical analysis, optical analysis, and microscopy.

11. The method of claim 9, wherein the at least one test sample comprises a coating comprising a nano-structured material.

12. The method of claim 11, wherein analyzing the at least one test sample comprises at least one process selected from the group consisting of reacting the coating with a reagent, dissolving a chemical species from the coating, desorbing a chemical species from the coating, and extracting a chemical species from the coating.

13. The method of claim 9, wherein analyzing the at least one test sample comprises detecting at least one material selected from the group consisting of CO₂, H₂S, chloride ions, iron ions, calcium ions, magnesium ions, chromium ions, manganese ions, hydroxyl ions, and hydronium ions.

14. The method of claim 9, wherein analyzing the at least one test sample comprises analyzing at least two regions of the at least one test sample to determine concentrations of at least two different chemical species.

15. The method of claim 9, wherein analyzing the at least one test sample comprises determining a physical property selected from the group consisting of pressure, temperature, fluid flow rate, vibration, acceleration, and electromagnetic field.

16. The method of claim 9, further comprising removing the sample array from the subterranean formation before analyzing the corrosion proxy and the at least one test sample.

17. The method of claim 9, further comprising maintaining the sample array within the subterranean formation for a period time from about six hours to about sixty days.

18. A method of characterizing conditions in a subterranean volume, comprising:
providing a plurality of sample arrays at longitudinally spaced locations in a borehole extending through one or more subterranean formations, each sample array comprising:
a substrate;
a corrosion proxy coupled to the substrate, the corrosion proxy formulated and configured to relate to corrosion of material near the sample array; and
at least one test sample coupled to the substrate, the at least one test sample formulated and configured to measure at least one of a physical property and a chemical species;
analyzing the corrosion proxy of each sample array to estimate corrosion experienced by each sample array;
analyzing the at least one test sample of each sample array to determine at least one property selected from the group consisting of a physical property experienced by each sample array and a concentration of a chemical species at the location of each array; and
correlating a location in the borehole with the corrosion and the at least one of a physical property and the concentration of the chemical species.

19. The method of claim 18, further comprising selecting a drilling location based at least partially on the corrosion and the at least one of a physical property and the concentration of the chemical species.

20. The method of claim 18, further comprising inspecting equipment used in the borehole extending through the one or more subterranean formations based on the corrosion and the at least one of a physical property and the concentration of the chemical species in the subterranean volume.
